(19) United States
(12) Patent Application Publication
(10) Pub. No.: US 2026/0291311 A1
(43) Pub. Date: Sep. 24, 2026

(54) FAN ASSEMBLY INCLUDING AN OPTIMISED MOTOR

(71) Applicant: |.M.E. INDUSTRIA MOTORI ELETTRICI S.P.A., Manerbio (Brescia) (IT)

(72) Inventor: Giampaolo RAPI, Manerbio (Brescia) (IT)

(21) Appl. No.: 19/472,164

(22) PCT Filed: Mar. 25, 2024
(86) PCT No.: PCT/IB2024/052841

§ 371 Date: Oct. 3, 2025

(30) Foreign Application Priority Data
Apr. 4, 2023 (IT) 102023000006600

(51) Int. Cl. H02K 1/2791; F04D 17/08; F04D 25/06; F04D 29/28; H02K 1/14; H02K 11/33; H02K 21/22

(52) U.S. Cl. CPC H02K 1/2791; F04D 17/08; F04D 25/06; F04D 29/281; H02K 1/146; H02K 11/33; H02K 21/22; H02K 2201/06; H02K 2211/03; H02K 2213/03

(57) ABSTRACT

A scroll-free plug fan has a blade group having an impeller with a radial or mixed flow, and a motor group operatively connected to the blade group to rotationally drive the motor group up to a maximum design speed. The maximum design speed is equal to about 3600 rpm. The motor group has a static drive shaft extending along an axis (X-X), a brushless electric motor having a stator supported by the drive shaft, and an outer rotor connected to the blade group rotating about the drive shaft. The rotor has a plurality of magnets, each having lateral sides inclined with respect to the axis (X-X) by a skew angle (α) between 1.5 and 10.5 degrees.

The present invention relates to an industrial fan assembly.

Specifically, the present invention is in the field of fan assemblies that operate at medium-low speed. More specifically, the present invention is in the field of centrifugal type fan assemblies, i.e., comprising a centrifugal impeller, and without an external casing enclosing the impeller, also known as a scroll or spiral.

Fan assemblies of this type are also known in the field as a “plug fan” or “plenum fan”. In general plug fan assemblies, by virtue of the centrifugal impeller, have higher performances than axial fans but perform less well than purely centrifugal fans due to the lack of a scroll. Fan assemblies of this type are in general used where there is the need for the handling of high airflow rates at medium-low pressures, typically employed within heating, ventilation and industrial air conditioning systems (HVAC applications).

Innovation in the field of fan assemblies is driven by constant optimization of the electrical machines which is influenced by new legislative impositions, environmental factors and the minimization of costs. In fact the sector requires fan assemblies that are cable of delivering elevated driving torque and that do not disregard aspects of fundamental importance, such as high efficiency, small size, low noise and a cost-effective design.

Solutions are known in the state of the art for high efficiency fan assemblies for industrial environments. The Applicant is, for example, the holder of the European patent application EP4006352A1, which addresses the optimization of the electric motor that moves the blade group of the fan assembly.

The object of the present invention is that of providing a fan assembly that fulfills all of the aforesaid requirements in having operating features that are optimized for a specific application, for minimizing environmental impact, for high efficiency and reducing costs.

Such object is achieved by means of a fan assembly in accordance with claim 1. The claims dependent on these show preferred variant embodiments involving a number of additional advantageous technical effects.

Further features and advantages of the invention will be apparent from the following description of preferred exemplary embodiments thereof and by the accompanying figures, wherein:

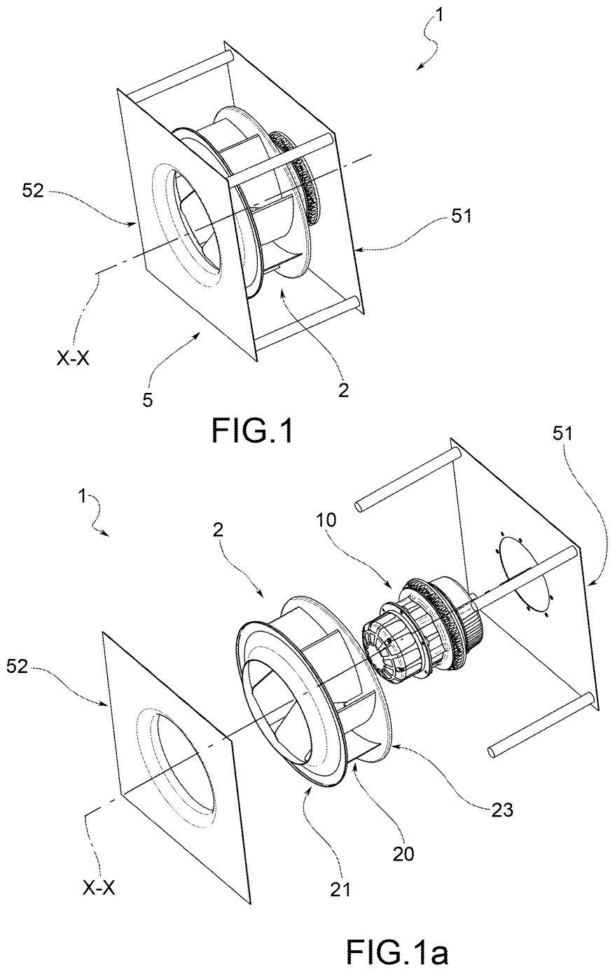

FIGS. 1 and 1a show a fan assembly in accordance with the present invention, with assembled and separated parts respectively, wherein the fan assembly is of the plug fan type;

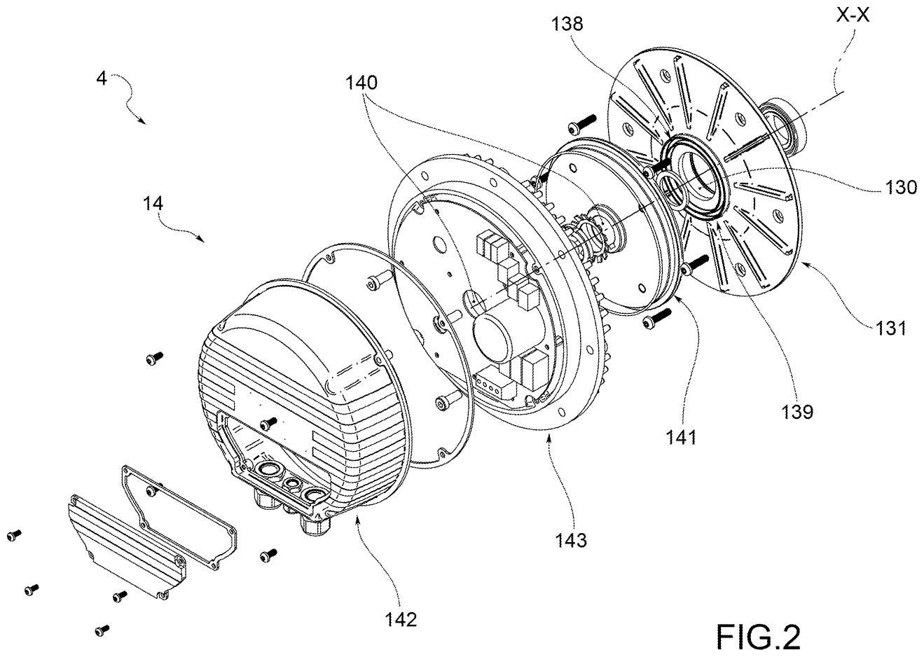

FIG. 2 depicts the auxiliary casing and the electronic board group in separate parts;

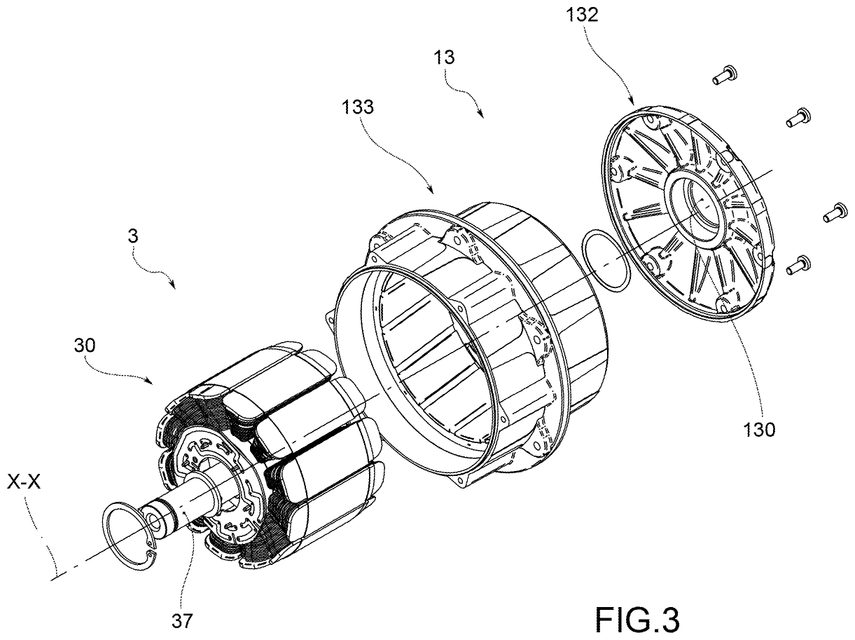

FIG. 3 shows the motor casing in separate parts and the motor group;

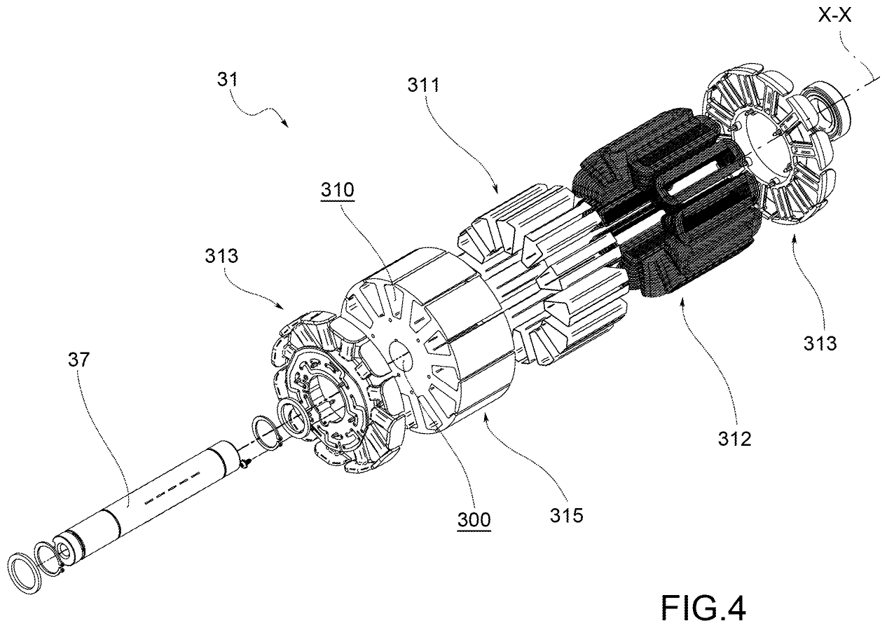

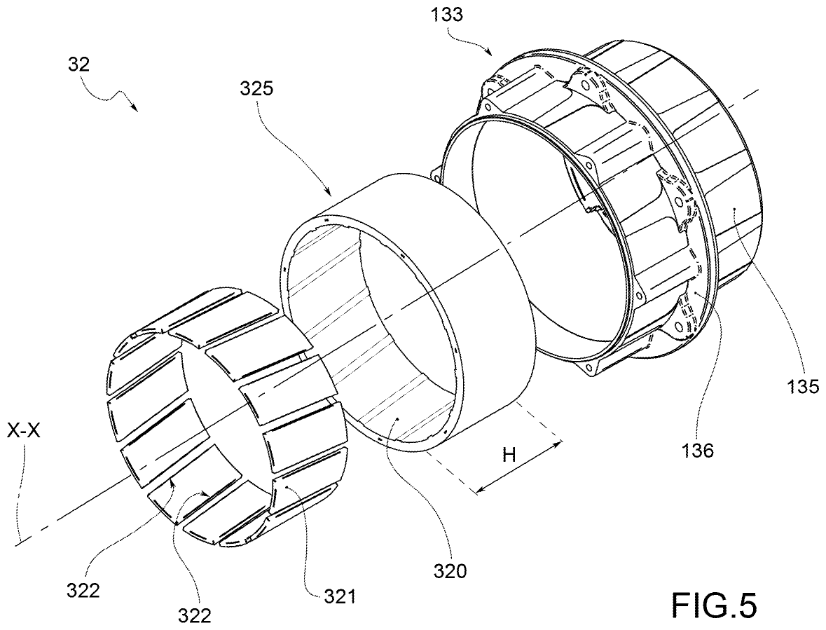

FIGS. 4 and 5 show some motor components as separate parts.

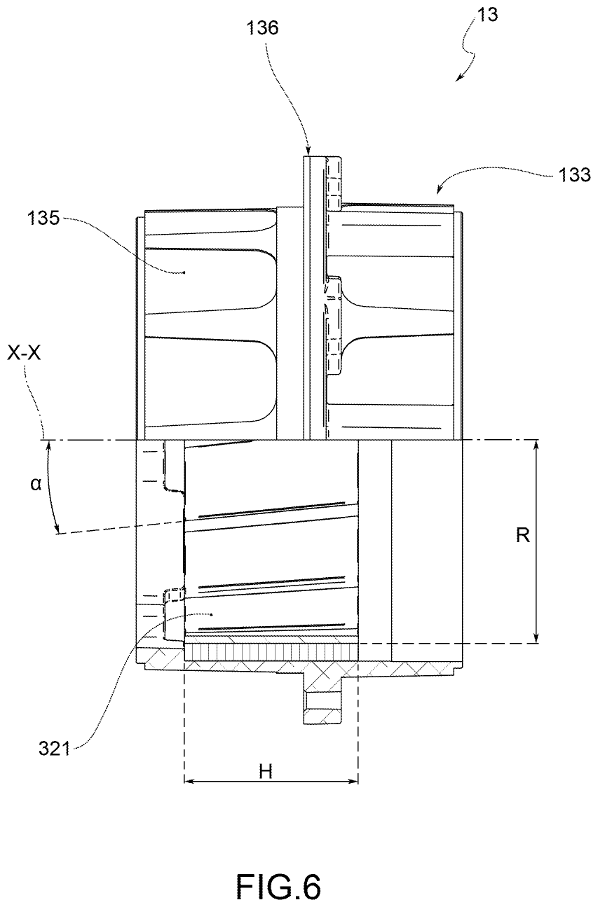

FIG. 6 represents a partial cross-section view of the motor casing and the rotor.

With reference to the accompanying figures, a fan assembly in the entirety thereof is indicated with the numeral 1.

In accordance with the present invention, the fan assembly 1 is a centrifugal fan, namely of the type wherein air is drawn in axially in proximity to the drive shaft and moved towards the outlet by means of deflection and centrifugal force in a radial direction with respect to the X-X axis.

In accordance with the present invention, the fan assembly 1 is of the plug fan or plenum fan type.

In particular, the term “plug fan” or “plenum fan” refers to a fan assembly 1 that is devoid of a casing (also known as a scroll or spiral) that encloses the impeller 20, preferably with rear curved blades, preferably using simple aspiration.

In other words, the region where the impeller is housed is devoid of a cylindrical side wall (scroll or spiral). In further other words, the impeller chamber is substantially accessible in a radial direction with respect to the X-X axis, the impeller is for example visible.

In accordance with the present invention, the fan assembly 1 comprises a blade group 2 having an X-X axis and comprising an impeller 20 with radial or mixed flow rotatable around the X-X axis.

According to one embodiment the impeller 20 comprises a plurality of blades that extend in a radial direction with respect to the X-X axis. The impeller 20 preferably comprises blades that are inclined either forwards or backwards.

The impeller 20 comprises a front disc 21 and a rear disc 23, both integrally connected to the axial ends of the impeller, for example welded to the axial ends of the blades. The front disc 21 has a front central opening, preferably defined by an appropriately shaped edge (known as a suction cone) for drawing in inlet air. The rear disc 23 has a rear central opening for the axial insertion of the external casing containing the motor group and the electronic board group. In an assembled configuration, the external casing containing the motor group and the electronic board group is at least partially radially arranged internally to the impeller, in particular to the blades.

According to one embodiment the fan assembly 1 comprises a support frame 5 that is suitable for supporting the blade group 2 and the motor group 3, and suitable for being linked to an external operating system, for example a movement and/or heating and/or ventilation and/or air conditioning system, packaging systems and similar systems that require an airflow.

According to one preferred embodiment, the support frame 5 comprises an upper anchorage plate 51 that is suitable for being mechanically connected to the external operating system, and a lower anchorage plate 52 that is axially spaced apart from the upper anchorage plate 51. Such lower anchorage plate 52 is mechanically connected to the upper anchorage plate 51, for example by means of a plurality of tubular connecting tubes 53 that extend along the X-X axis.

In one embodiment, the lower anchorage plate 52 is proximal to the front disc 21 of the impeller 20 along the X-X axis.

The fan assembly 1 comprises an electronic board group 4 that is either configured or configurable to electronically drive the motor group 3.

The electronic board group 4 is either configured or configurable to drive the impeller 20 to rotate by means of electronically controlling the motor group 3, in a variable manner within a predefined range of speeds. Such range of speeds is between a predefined minimum design speed, for example zero speed, and a predefined maximum design speed.

In one embodiment, the maximum design speed is about 3600 rpm.

In one embodiment, the maximum design speed is about 3000 rpm.

According to one embodiment, the maximum design speed is about 1800 rpm.

In accordance with the present invention, the fan assembly 1 comprises a motor group 3 that is suitable for commanding the rotation of the blade group 2 about the X-X axis. The motor group 3 comprises a brushless electric motor 30 comprising a stator 31 and a rotor 32.

The electric motor 30 is preferably configured to deliver mechanical power equal to, or greater than, 3500 Watts.

In accordance with the present invention, the electric motor 30 is of the external rotor type, namely of the type wherein the rotor 32 extends both axially and at least partially circumferentially about the stator 31.

The stator 31 comprises a stator pack 315 comprising a plurality of magnetic stator laminations stacked along the X-X axis, having a reduced thickness and a substantially planar shape.

The stator pack 315 has a predefined axial dimension (stator pack length) that is chosen as a function of the nominal value of motor torque required.

The stator pack 315 preferably has a dimension along the X-X axis between 35 and 90 mm (substantially corresponding to the length of the stator pack).

Each stator lamination comprises a central lamination opening, passing axially within the thickness of the stator lamination, and a plurality of stator lamination slots arranged radially about the central lamination opening, which also pass axially through the thickness of the lamination. The axial alignment of the stator laminations defines, along the X-X axis, a main through opening 300 centrally and a plurality of stator through slots 310, arranged circumferentially about the main opening 300.

Housed within each stator slot 310 are elements 311 that isolate the base of the stator slot and the stator windings 312.

The stator comprises elements that isolate those parts that are live, in particular the winding and the electrical connections, from accessible metallic parts, such as the stator pack and the drive shaft. Such isolation elements comprise isolator heads 313 arranged at the axial ends of the stator pack, and isolating washers arranged axially along the drive shaft.

In accordance with the present invention, the motor group 3 comprises a drive shaft 37 extending axially along the X-X axis. The drive shaft 37 is static, i.e., it does not rotate about the X-X axis.

The drive shaft 37 is integrally engaged with the stator 31, in particular it is inserted into the main opening 300 of the stator pack 315, for example by means of a geometric interference coupling. The stator 31 and the drive shaft 37 are static and integrally connected therebetween.

In one embodiment, the drive shaft 37 is hollow, i.e., it has an opening passing axially through the shaft. A plurality of electrical connection cables is housed within the hollow drive shaft operatively connecting the electronic board group 14 to the stator 31, in particular to the stator windings 352, enabling dedicated electronic control. In this sense the motor group 3 is of the type comprising integrated electronic control.

In one embodiment, the drive shaft 37 comprises external surfaces that are at least partially covered with an electrically isolating material, for example a material belonging to the family of ceramic materials.

The drive shaft 37 comprises one or more support portions that are engaged respectively by bearings, for example roller elements. Such support portions are preferably at least partially covered with an electrically isolating material.

In one embodiment, the fan assembly 1 comprises an external casing 10 for internally housing the electric motor group 3 and preferably the electronic board group 4.

The external casing 10 comprises a motor casing 13 for containing the motor group 3, in particular the electric motor 30 and the drive shaft 37.

Preferably, the external casing 10 also comprises an auxiliary casing 14 for containing the electronic board group 4, arranged adjacent to the motor casing 13 along the X-X axis.

The auxiliary casing 14 comprises a bottom cover 142 that axially delimits the auxiliary casing 14. The bottom cover 142 comprises the cable glands for inserting the electronic board group electrical power supply cables.

The auxiliary casing 14 comprises a support flange 143, whereto the electronics components of the electronic board group 14 are attached. The support flange 143 preferably comprises cooling fins. The bottom cover 142 is preferably attached to the support flange 143, for example by means of circumferential screws.

The auxiliary casing 14 comprises a connection flange 141 for connecting the mechanical connection of the support flange 143 to the drive shaft 37.

The connection flange 141 and the support flange 143 are static, insofar as they are supported by the static drive shaft 37. In particular, the connection flange 141 and/or the support flange 143 comprise respective connection windows 140 wherein to the drive shaft 37 is inserted.

The motor casing 13 comprises a separation plate 131 and an opposite closure cover 132, axially spaced apart.

The closure cover 132 axially delimits the motor casing 13.

Preferably, the separation plate 131 separates the motor casing 13 from the auxiliary casing 14.

The motor casing 13 comprises bearing housing seats, wherein the bearings are housed that are operatively engaged with the drive shaft 37, for example bearing with roller elements. By means of such bearing engaged with the static drive shaft 37, the motor casing 13 may be rotated about the X-X axis.

In one embodiment, the separation plate 131 and/or the closure cover 132 comprise bearing 130 housing seats, wherein the bearings are housed that engage with the drive shaft 37.

In one embodiment, the separation plate 131 and the closure cover 132 are obtained by die casting, preferably from a metallic material, for example aluminum alloy.

According to one embodiment, the separation plate 131 and/or the closure cover 132 comprise respective through openings along the X-X axis, whereinto the drive shaft 37 is inserted.

The motor casing 13 comprises a rotor casing 133 for housing the rotor 32, for example axially between the separation plate 131 and the closure cover 132.

The rotor casing 133 comprises a casing side wall 135 extending along the X-X axis, for example having a substantially cylindrical shape, and an external flange 136 protruding from the casing side wall 135, for example having a substantially annular shape.

The blade group 2, in particular the impeller 20, is mechanically engaged with the motor casing 13, in particular with the rotor casing 133, it is preferably mechanically attached to the external flange 136, for example by means of screws.

In other words, the blade group 2 is integrally connected to the motor casing 13 to rotate, in particular to the rotor casing 133, rotatable by means of the bearings support and by the static drive shaft 37.

The rotor 32 comprises a rotor pack 325 comprising a plurality of magnetic rotor laminations stacked along the X-X axis, having a reduced thickness and a substantially annular shape.

The stacking of the rotor laminations defines the axial dimension of the rotor pack 325. The rotor pack 325 preferably has a dimension along the X-X axis between 35 and 90 mm (substantially corresponding to the length of the rotor pack).

The rotor pack 325 is mechanically connected to the motor casing 13 to rotate, preferably interference housed within the rotor casing 133.

In one assembled motor group 3 configuration, the blade group 2, the rotor 32 and the motor casing 13 are rotatable about the X-X axis, whilst the drive shaft 37 and the stator 31 are static.

Each rotor lamination comprises a circular crown extending about the X-X axis, having an inner boarder radially facing the stator and an opposite external border. Each rotor lamination comprises a plurality of rotor lamination slots radially lowered into the inner edge of the circular crown, these also pass through the thickness of the lamination. Specifically, each rotor lamination comprises slot perimeter edges that define the geometry of the rotor lamination slots.

The stacking of the rotor laminations define a plurality of rotor slots 320 arranged along circumferentially about the X-X axis.

Reported in the following Table 1 are five embodiments, wherein for each embodiment the axial length is indicated of the stator pack in millimeters (stack length [mm]), the nominal motor torque range in Newton·meters (torque range [N·m]) and the rotational speed range in revolutions per minute (speed range [rpm]).

TABLE 1
exemplary embodiments.

| Stack | Torque | Speed |
|---|---|---|
| length [mm] | range [Nm] | range [rpm] |
| 35 | 12 to 16 | 2000 to 3000 |
| 45 | 16 to 21 | 1500 to 2700 |
| 55 | 21 to 26 | 1200 to 2500 |
| 70 | 26 to 32 | 1000 to 1800 |
| 90 | 32 to 41 | 700 to 1300 |

Housed within each rotor slot 320, preferably glued, are one or more magnets 321 arranged along and about the X-X axis. The magnets are preferably directly facing the stator 31.

The magnets 321 are preferably permanent rare earth magnets, for example neodymium, dysprosium, praseodymium, cobalt or the alloys thereof.

The electric motor 30 is preferably of the type belonging to the family of electric motors known as PMSM (Permanent Magnet Synchronous Motor).

In axial cross-section each magnet 321 has, substantially, the shape of a sector of an arc of a circle, delimited circumferentially by two magnet lateral sides, and having a thickness that is reduced in the radial direction, defined between an inner edge magnet and an opposite outer edge magnet facing the bottom of the rotor slot.

In one embodiment, the magnets 321 have a substantially linear shape along the X-X axis, i.e., they have magnet lateral sides parallel to the X-X axis.

In accordance with the present invention, the magnet 321 have magnet lateral sides 322 extending along the X-X axis in an inclined manner with respect to the X-X axis with a predefined angle of inclination or skew angle α between 1.5 and 10.5 degrees, preferably between 3 and 9 degrees, for example about 6 degrees.

Theoretical values for the skew angle α (radians) may be obtained from the following formula:

α(rad)=tan⁻¹(2*R*0.04416/H)

wherein “R” is the radius of the outer edge of the magnet, i.e., the outer edge of the magnet directly facing the rotor slot, and “H” is the dimension of the stator pack 315 along the X-X axis.

On an experimental basis and by means of simulation, the Applicant has observed that optimal actual values for the fan assembly are comprised with a range of admissible tolerances equal to ±20% of the optimal theoretical value obtained by means of the formula given above.

In one embodiment, the rotor laminations are stacked and rotated, one with respect to the other, along and about the X-X axis, in such a way as to define rotor slots 320 inclined along the X-X axis, suitable for housing the magnets 321 with inclined lateral sides 322.

In other words, the rotor slots 320 progress in an inclined manner along and about the X-X axis with an inclination that substantially equal to the skew angle α.

The electric motor is of the Fractional Slot type, i.e., of the type wherein the ratio between the number of stator slots and the number of rotor poles, per electric motor phase, is a fractional number.

In a preferred embodiment, the rotor 32 comprises fourteen rotor poles.

In a preferred embodiment, the stator 31 comprises twelve stator slots.

In a preferred embodiment, the electric motor is three-phase and has twelve stator slots and fourteen rotor poles. The number of slots per pole per phase is therefore about 12/(14*3)=0.2857.

In particular, the Applicant has observed that, in the three-phase electric motor embodiment having fourteen rotor poles and twelve stator slots, the axial length of the stator pack is equal to 70 mm, the optimal angle of inclination or skew angle α (radians) is equal to around 6 degrees, with an admissible tolerance equal to ±20%.

The fan assembly 1 comprises one or more gaskets and sealing systems, for example specific gaskets and/or labyrinth seals.

An annular gasket is preferably comprised between the bottom cover 142 and the support flange 143. An annular gasket is preferably comprised between the support flange 143 and the connection flange 141.

The separation plate 131 preferably comprises an annular lip 138 protruding axially in proximity to the bearing housing seat 130, having a labyrinth seal 139 that is suitable for reducing or preventing the leakage of liquids along the X-X axis.

Innovatively, the fan assembly fully fulfills the predetermined objective overcoming the typical issues of the prior art, insofar as it is characterized by high energy efficiency within the given range of rotational speed of the blade unit, as required in the field for a specific application.

Advantageously, with the same material for the magnets and with the same geometry and magnetic material for the stator pack 315, a three-phase electric motor having twelve stator slots and fourteen rotor poles has an elevated deliverable drive torque constant, for a given electrical current in the electric motor phases.

Advantageously, the magnetic flux reclosing path between the magnets is reduced and thus results in a reduction of the magnetic induction within the rotor pack 325. Advantageously, this enables a reduction in the length of the rotor pack 325, i.e., of the axial footprint thereof, maintaining invariant the induction obtained, therefore an increase in the diameter at the air gap of the electric motor. All of this indirectly enables a further increase in the deliverable mechanical torque, insofar as the useful lever of the blades increases.

Advantageously, the inclination of the magnet lateral sides, by one skew angle, makes it possible to minimize undesired torque ripple and therefore any relative loss of drive torque.

Such torque ripple is typical in fractional slot electric motors and is particularly accentuated in electric motors that have an elevated number of rotor poles with high energy density magnets, in particular rare earth magnets.

Torque ripple is highly undesirable for such electric motors, insofar as an increment in the number of rotor poles corresponds to a high range of torque ripple frequencies, for a given range of mechanical rotational speeds of the electric motor. At a high range of torque ripple frequencies there is a corresponding high possibility of intercepting and exciting one or more of the mechanical resonant frequencies thereof of the motor (external casing, rotor pack, stator pack, etc.). In such case a high level of noise would occur.

Advantageously, the skew minimizes the anisotropy of the magnetic circuit and improves the distribution of the magnetic flux at the air gap.

Advantageously, the skew improves the waveform of the counter electromotive force, making it approximate to a sinusoidal curve.

Advantageously, the fan assembly minimizes those direct and indirect costs that are due to employing rare earth magnets. Such magnets are obtained by means of processes for the sintering of chemical elements aimed at forming a single block. The magnets are obtained by means of waste material removal or electro-discharge machining (EDM). Advantageously, a reduction in the chord of arc magnets and a high number of rotor poles results in a reduction in the quantity of material removed and therefore an increased use of the raw material.

Advantageously, the insulating material coating implemented upon the support portions of the drive shaft prevents or minimizes the completing of any electrical currents induced by capacitive electrical dispersions through the metallic materials of the bearings, for example through the balls of the roller bearings.

Advantageously, the dimensions of the electric motor, for the same power output, are reduced with respect to the electric motors that are typically used in the prior art.

Advantageously, the overall reduction in the footprint of the motor allows for an increase in the air passage cross-section, resulting in improved performance of the fan assembly.

Advantageously, a reduction in the axial dimensions of the motor, in particular of the rotor, minimizes the obstruction to the airflow at the inlet to the impeller, with a consequent loss in deliverable airflow.

Advantageously, the electric motor has footprint dimensions that are optimized for specific use in “plug fan” assemblies.

Advantageously, the fan assembly features high electrical efficiency (high drive torque generated for the same current drawn) over a broad range of impeller rotational speeds, in particular it features high electrical efficiency at low rotational speeds.

Advantageously, the fan assembly achieves a trade-off between maximizing the rotational speeds of the blade assembly and minimizing the increase in electrical frequency and losses due to eddy currents and magnetic hysteresis.

Advantageously, the rotor is provided with a high number of poles, a feature that is useful for optimizing the torque-speed curve of the motor, with specific reference to the features of the blade group.

It is clear that a person skilled in the art may make changes to the invention described above in order to meet contingent needs, which changes all fall within the scope of protection as defined in the following claims.

What is claimed is:

1-11. (canceled)

12. A scroll-free plug fan for medium-low speed ventilation, comprising:
a blade group controllable to rotate about an axis (X-X), comprising a radial-flow or mixed-flow impeller;
a motor group operatively connected to the blade group to rotationally drive the blade group up to a maximum design speed, wherein the maximum design speed is preferably equal to about 3600 rpm, wherein the motor group comprises:
i) a static drive shaft extending along the axis (X-X), and
ii) a three-phase permanent magnet synchronous motor comprising:
an inner stator supported by the static drive shaft and having twelve stator slots; and
an outer rotor connected to the blade group rotating about the static drive shaft,
wherein the outer rotor comprises a rotor pack having an axial length between 35 and 90 millimeters and consisting of a plurality of thin annular rotor laminations axially stacked, the stacking of rotor laminations defining fourteen rotor slots, wherein the outer rotor further comprises permanent magnets made of rare earths, each housed in a rotor slot, wherein each of the permanent magnets comprises lateral sides inclined with respect to the axis (X-X) by a skew angle (α) between 3 and 9 degrees, and wherein the rotor laminations are mutually rotated about the axis (X-X) so that the rotor slots extend with respect to the axis (X-X) at an angle substantially equal to the skew angle (α).

13. The scroll-free plug fan of claim 12, further comprising a support frame for anchoring the scroll-free plug fan to an external operating system, optionally the external operating system being a ventilation system, an air conditioning system, or an air heating system, wherein the support frame comprises a pair of anchorage plates mechanically connected to each other, and wherein the impeller is axially accommodated between the pair of anchorage plates.

14. The scroll-free plug fan of claim 12, further comprising a motor casing in which the permanent magnet synchronous motor is accommodated, wherein the blade group is mechanically connected to the motor casing, both being rotatable about the static drive shaft.

15. The scroll-free plug fan of claim 14, wherein the outer rotor is integrally connected to the motor casing rotating about the axis (X-X).

16. The scroll-free plug fan of claim 14, comprising an electronic board group to electronically command the permanent magnet synchronous motor, wherein the scroll-free plug fan comprises an auxiliary casing positioned axially adjacent to the motor casing, in which the electronic board group is accommodated.

17. The scroll-free plug fan of claim 12, wherein the maximum design speed is of about 3600 rpm.

18. The scroll-free plug fan of claim 17, wherein the maximum design speed is of about 1800 rpm.

19. The scroll-free plug fan of claim 12, wherein the skew angle (α) is about 6 degrees.

20. The scroll-free plug fan of claim 12, wherein the skew angle (α) is comprised in a ±20% range of a theoretical value obtained by the formula α=arctan(2*R*0.04486/H), and wherein R is a radius of an outer edge of the permanent magnet into the rotor slot, and H is an axial length of a stator pack.
